(19) United States
(12) Patent Application Publication
(10) Pub. No.: US 2018/0216400 A1
(43) Pub. Date: Aug. 2, 2018

(54) DOOR ASSEMBLY INCLUDING PANEL SECTIONS

(71) Applicant: 2350786 Ontario Ltd., Aurora (CA)

(72) Inventors: Stewart McLaren, Aurora (CA); Greyden Hart, Keswick (CA); Vern Cunningham, Aurora (CA)

(73) Assignee: 2350786 Ontario Ltd., Aurora (CA)

(21) Appl. No.: 15/420,251

(22) Filed: Jan. 31, 2017

(51) Int. Cl. E06B 7/14; E06B 3/44; E06B 3/70

(52) U.S. Cl. CPC E06B 7/14; E06B 2003/7044; E06B 3/70; E06B 3/44

(57) ABSTRACT

An apparatus includes a door assembly including panel sections. A water drainage assembly is configured to (A) be located, at least in part, between the panel sections, (B) receive, in use, a flow of water from the panel sections once the panel sections are aligned in the second position, (C) direct, in use, the flow of water away from the panel sections, and (D) direct, in use, the flow of water extending from the panel sections.

### TECHNICAL FIELD

This document relates to the technical field of (and is not limited to) a door assembly including panel sections with a water drainage assembly (and method therefor). In addition, this document relates to the technical field of (and is not limited to) a door assembly including panel sections with a cooling channel (and method therefor).

### BACKGROUND

A roll-up door (also called a garage door, etc.) is a door configured to open either manually or by a door-opener device (operated by an electric motor, pneumatic device, etc., or any equivalent thereof. The roll-up door includes jointed panels configured to move (roll up, roll down) on tracks across the garage ceiling (or a truck ceiling) to a position located above the doorway, etc. The roll-up door may include an operating mechanism that is spring-loaded or counterbalanced to offset the weight of the roll-up door, and preferably to reduce the human effort (to be provided by the user) and/or mechanized effort (to be provided by the door-opener device) required to operate (to move) the roll-up door. Roll-up doors may be made of any suitable construction material, such as (and not limited to) wood, metal, thermoplastic material, and/or fiberglass (in any combination and/or permutation thereof), and may be further thermally insulated to prevent heat loss (if so desired).

### SUMMARY

It will be appreciated that there exists a need to mitigate (at least in part) at least one problem associated with the existing door assemblies (also called the existing technology). After much study of the known systems and methods with experimentation, an understanding of the problem and its solution has been identified and is articulated as follows:

The known door assembly (also called a roll-up door) permits a flow of water downwardly from panel sections of the door assembly in such a way that the flow of water may reach a working surface located directly underneath (directly behind or behind) a central zone of the panel sections once the panel sections are aligned (horizontally aligned).

This is inconvenient for the case where there is an item stored or positioned directly underneath (directly behind or behind) the central zone of the panel sections once the panel sections are aligned (such as, horizontally aligned). The reason for this is that the item may become inadvertently water damaged.

To mitigate, at least in part, at least one problem associated with the existing technology, there is provided (in accordance with a major aspect) an apparatus. The apparatus includes a door assembly. The door assembly includes panel sections. A water drainage assembly is configured to:(A) be located, at least in part, between the panel sections, (B) receive, in use, a flow of water from the panel sections once the panel sections are aligned, (C) direct, in use, the flow of water away from the panel sections, and (D) direct, in use, the flow of water from the panel sections (this is done in such a way that the water drainage assembly, in use, diverts conveyance of the flow of water away from a working surface located directly underneath (directly behind or behind) a central zone of the panel sections once the panel sections are aligned).

To mitigate, at least in part, at least one problem associated with the existing technology, there is provided (in accordance with a major aspect) an apparatus. The apparatus includes a door assembly. The door assembly includes panel sections configured to: (A) be pivotally coupled with each other in such a way that the panel sections are positioned in an end-to-end relationship relative to each other, (B) have an outer panel surface configured to receive moisture, (C) have a central zone, (D) have opposite peripheral shortened side edges positioned on opposite sides of the central zone, (E) have opposite lateral side ends extending between the opposite peripheral shortened side edges, and (F) be movably coupled to spaced-apart door tracks in such a way that the panel sections are movable along the spaced-apart door tracks between a first position, in which the panel sections are aligned, and a second position, in which the panel sections are aligned. A water drainage assembly is configured to be located, at least in part, between the panel sections (this is done in such a way that the water drainage assembly is securely positioned between, at least in part, the water drainage assembly between the panel sections once the panel sections are aligned in the second position).

To mitigate, at least in part, at least one problem associated with the existing technology, there is provided (in accordance with a major aspect) an apparatus. The apparatus includes a water drainage assembly configured for use with a door assembly including panel sections. The panel sections are configured to: (A) be pivotally coupled with each other in such a way that the panel sections are positioned in an end-to-end relationship relative to each other, (B) have an outer panel surface configured to receive moisture (such as snow and ice or rain, or any type or precipitation), (C) have a central zone, (D) have opposite peripheral shortened side edges positioned on opposite sides of the central zone, (E) have opposite lateral side ends extending between the opposite peripheral shortened side edges, and (F) be movably coupled to spaced-apart door tracks in such a way that the panel sections are movable along the spaced-apart door tracks between a first position, in which the panel sections are aligned, and a second position, in which the panel sections are aligned. The water drainage assembly is configured to be located, at least in part, between the panel sections in such a way that the water drainage assembly is securely positioned between, at least in part, the panel sections once the panel sections are aligned in the second position.

To mitigate, at least in part, at least one problem associated with the existing technology, there is provided (in accordance with a major aspect) an apparatus. The apparatus includes a door assembly. The door assembly includes panel sections configured to be pivotally coupled with each other in such a way that the panel sections are positioned in an end-to-end relationship relative to each other. The panel sections are also configured to be movably coupled to spaced-apart door tracks in such a way that the panel sections are movable along the spaced-apart door tracks between a first position, in which the panel sections are aligned (vertically aligned), and a second position, in which the panel sections are aligned (such as, horizontally aligned). A water drainage assembly is configured to: (A) be positioned between the panel sections; (B) receive, at least in part, water positioned on a surface of the panel sections once the panel sections are aligned (such as, horizontally aligned); and (C) direct a flow of the water toward opposite lateral side ends of the panel sections. The water drainage assembly, in use, avoids the release of water toward a central floor area positioned directly underneath (directly behind or behind) the panel sections that are positioned (such as, positioned horizontally).

To mitigate, at least in part, at least one problem associated with the existing technology, there is provided (in accordance with a major aspect) an apparatus. The apparatus includes a door assembly. The door assembly includes panel sections configured to be pivotally coupled with each other in such a way that the panel sections are positioned in an end-to-end relationship relative to each other. The panel sections are also configured to be movably coupled to spaced-apart door tracks in such a way that the panel sections are movable along the spaced-apart door tracks between a first position, in which the panel sections are aligned (vertically aligned), and a second position, in which the panel sections are aligned (such as horizontally aligned). The panel sections have an outer surface configured to receive and support a logo; and the panel sections are also configured to form an insulation channel configured to receive a thermal insulation material in such a way that the thermal insulation material, in use, builds up heat energy on the outer surface of the panel sections having the logo. The panel sections are also configured to form a cooling channel configured to receive air. The cooling channel is configured to be positioned proximate to the insulation channel in such a way that the cooling channel, in use, receives the heat energy from the outer surface of the panel sections having the logo, and conducts the heat energy away from the outer surface and the logo. The outer surface of the panel sections is less likely to inadvertently buckle in response to receiving the heat energy, and the logo installed to the panel sections does not warp in response to the outer surface being buckled in response to receiving the heat (thermal energy).

To mitigate, at least in part, at least one problem associated with the existing technology, there is provided (in accordance with a major aspect) an apparatus. The apparatus includes a gutter assembly configured to (A) connect to spaced-apart door tracks, and (B) fluidly cooperate with a water drainage assembly associated with panel sections of a door assembly configured to be operatively mounted to the spaced-apart door tracks in such a way that the auxiliary gutter assembly, in use, receives the flow of water along a directionally-aligned drain path from the water drainage assembly at the opposite peripheral shortened side edges of the panel sections. In accordance with an option, the gutter assembly is configured to be retrofitted to the spaced-apart door tracks. Preferably, the auxiliary gutter assembly is configured to direct the flow of water along a direction (along an elongated length of the auxiliary gutter assembly) toward the position in which the door assembly is positioned in alignment (orientation). In accordance with an option, the spaced-apart door tracks is configured to be integrated with the gutter assembly. The spaced-apart door tracks integrated with the gutter assembly is configured to fluidly cooperate with the water drainage assembly of the panel sections. This is done in such a way that the spaced-apart door tracks, in use, receives the flow of water from the water drainage assembly. Once the flow of water is received by the spaced-apart door tracks from the water drainage assembly, the spaced-apart door tracks is configured to direct the flow of water along a lateral direction along an elongated length of the spaced-apart door tracks toward the position in which the door assembly is positioned in alignment.

To mitigate, at least in part, at least one problem associated with the existing technology, there is provided (in accordance with a major aspect) an apparatus. The apparatus includes a door assembly including panel sections. A water drainage assembly is configured to (A) be located, at least in part, between the panel sections, (B) receive, in use, a flow of water from the panel sections once the panel sections are aligned (such as horizontally aligned) in the second position, (C) direct, in use, the flow of water away from the panel sections, and (D) direct, in use, the flow of water extending downwardly from the panel sections.

To mitigate, at least in part, at least one problem associated with existing technology, there is provided (in accordance with a major aspect) a method. The method is for operating a water drainage assembly that is configured for use with a door assembly including panel sections. The panel sections are configured to (A) be pivotally coupled with each other in such a way that the panel sections are positioned in an end-to-end relationship relative to each other, (B) have an outer panel surface configured to receive moisture (such as snow and ice or rain, etc.), (C) have a central zone, (D) have opposite peripheral shortened side edges positioned on opposite sides of the central zone, (E) have lateral side ends extending between the opposite peripheral shortened side edges, and (F) be movably coupled to spaced-apart door tracks in such a way that the panel sections are movable along the spaced-apart door tracks between a first position, in which the panel sections are aligned (vertically aligned), and a second position, in which the panel sections are aligned (such as, horizontally aligned). The method includes locating, at least in part, the water drainage assembly between the panel sections. This is done in such a way that the water drainage assembly is securely positioned between, at least in part, the panel sections once the panel sections are aligned (horizontally aligned) in the second position. The water drainage assembly, in use, provides a directionally aligned drain path (such as a horizontal drain path) extending along the lateral side ends of the panel sections from the central zone of the panel sections to the opposite peripheral shortened side edges of the panel sections). This is done in such a way that the directionally aligned drain path: (A) receives, in use, a flow of water from the moisture (such as, snow and ice, or rain) positioned on the outer panel surface of the panel sections once the panel sections are aligned (horizontally aligned) in the second position; (B) directs, in use, the flow of water away from the central zone of the panel sections and toward the opposite peripheral shortened side edges of the panel sections; (C) directs, in use, the flow of water along a vertical drain path extending downwardly from the opposite peripheral shortened side edges of the panel sections once the flow of water reaches the opposite peripheral shortened side edges of the panel sections; and (D) directs, in use, the flow of water downwardly from the panel sections in such a way that the water drainage assembly, in use, diverts the conveyance of the flow of water away from a working surface located directly underneath (or directly behind or behind) a central zone of the panel sections once the panel sections are aligned (horizontally aligned). The water drainage assembly, in use, avoids conveyance of the flow of water, once the panel sections are aligned (horizontally aligned), from the central zone of the panel sections to a working surface located directly underneath (or directly behind or behind) the central zone of the panel sections.

Other aspects are identified in the claims. Other aspects and features of the non-limiting embodiments may now become apparent to those skilled in the art upon review of the following detailed description of the non-limiting embodiments with the accompanying drawings. This Summary is provided to introduce concepts in simplified form that are further described below in the Detailed Description. This Summary is not intended to identify key features or essential features of the disclosed subject matter, and is not intended to describe each disclosed embodiment or every implementation of the disclosed subject matter. Many other novel advantages, features, and relationships will become apparent as this description proceeds. The figures and the description that follow more particularly exemplify illustrative embodiments.

### DETAILED DESCRIPTION OF THE DRAWINGS

The non-limiting embodiments may be more fully appreciated by reference to the following detailed description of the non-limiting embodiments when taken in conjunction with the accompanying drawings, in which:

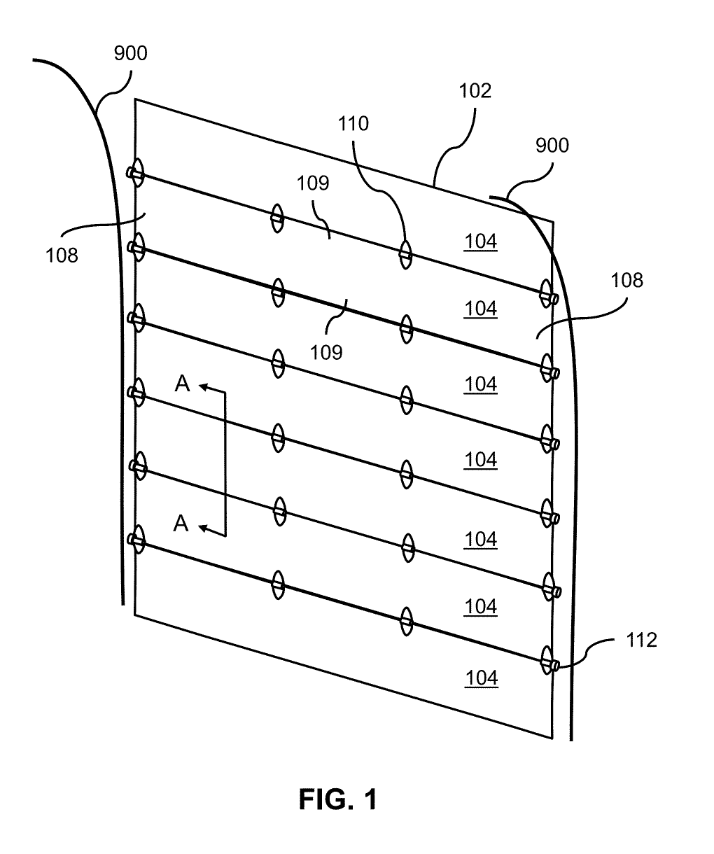

FIG. 1 depicts a perspective view of an embodiment of spaced-apart door tracks configured to support a door assembly including panel sections;

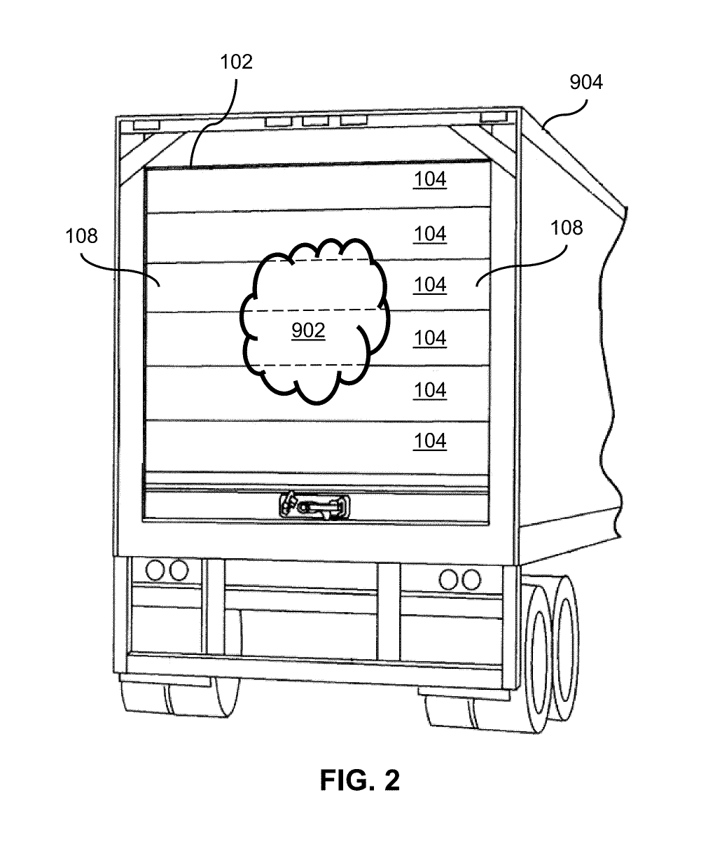

FIG. 2 depicts a perspective view of an embodiment of the door assembly of FIG. 1;

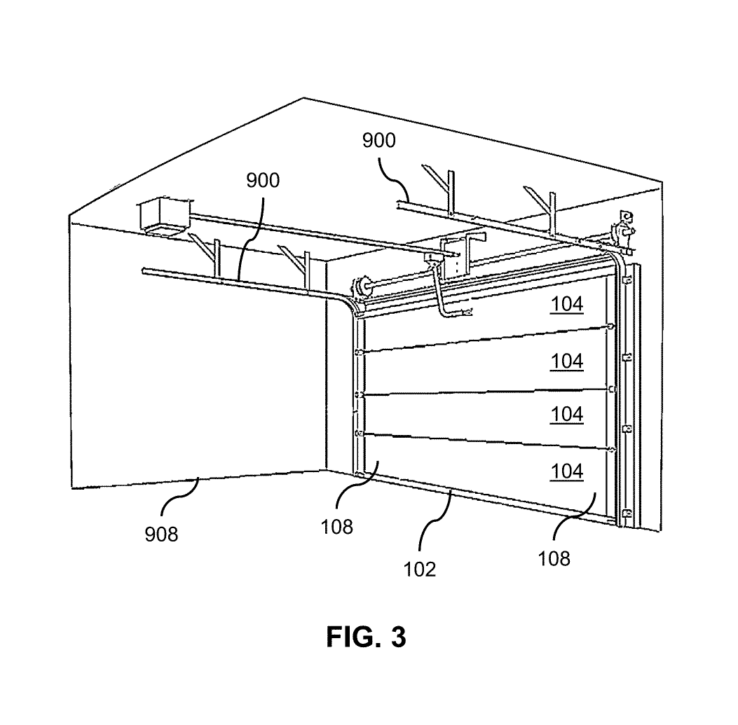

FIG. 3 depicts a perspective view of an embodiment of the door assembly of FIG. 1;

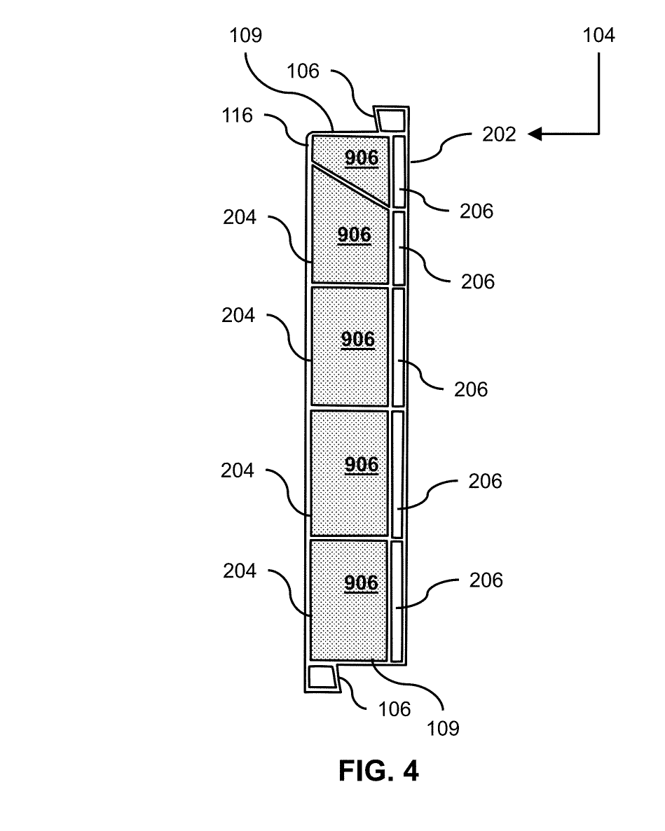

FIG. 4 depicts a cross-sectional side view (taken along the cross-sectional line A-A of FIG. 1) of an embodiment of the panel section of the door assembly of FIG. 1;

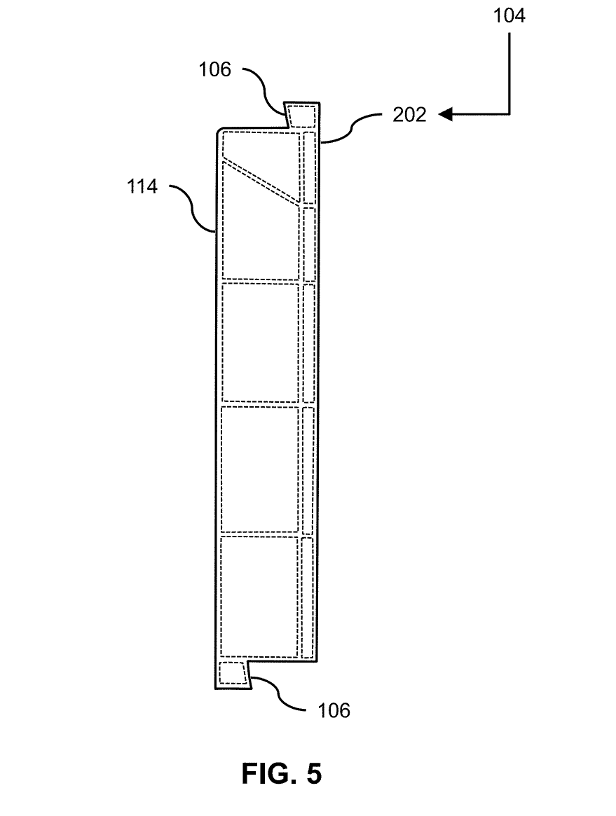

FIG. 5 depicts a cross-sectional side view (taken along the cross-sectional line A-A of FIG. 1) of an embodiment of the panel section of the door assembly of FIG. 1;

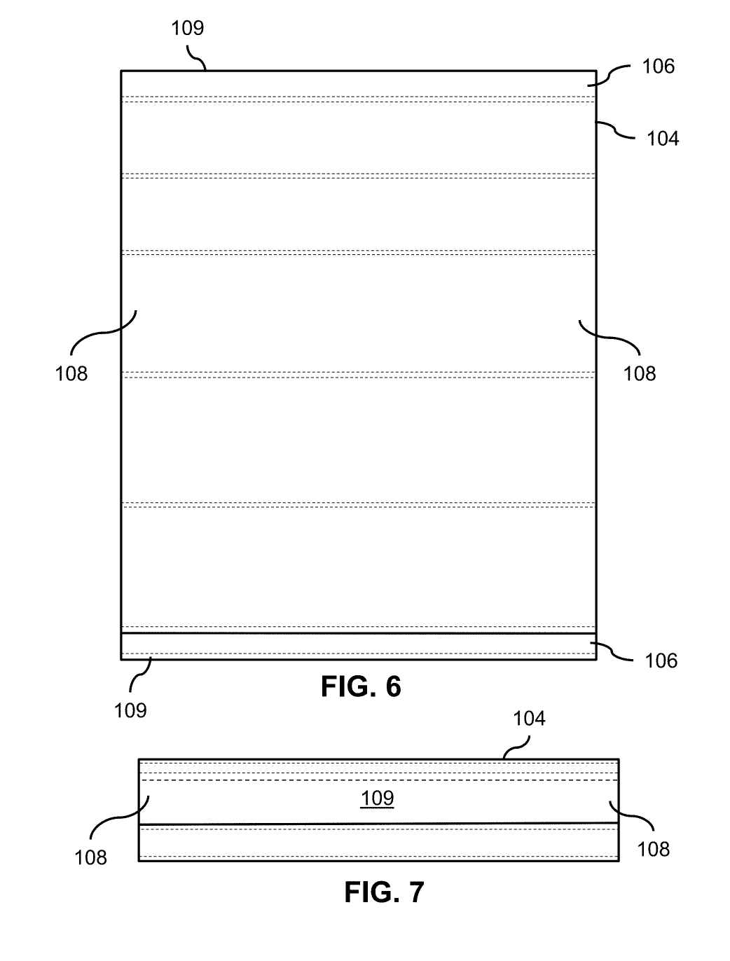

FIG. 6 and FIG. 7 depict a front view (FIG. 6) and a bottom view (FIG. 7) of an embodiment of the door assembly of FIG. 1 (in which the panel sections are vertically aligned);

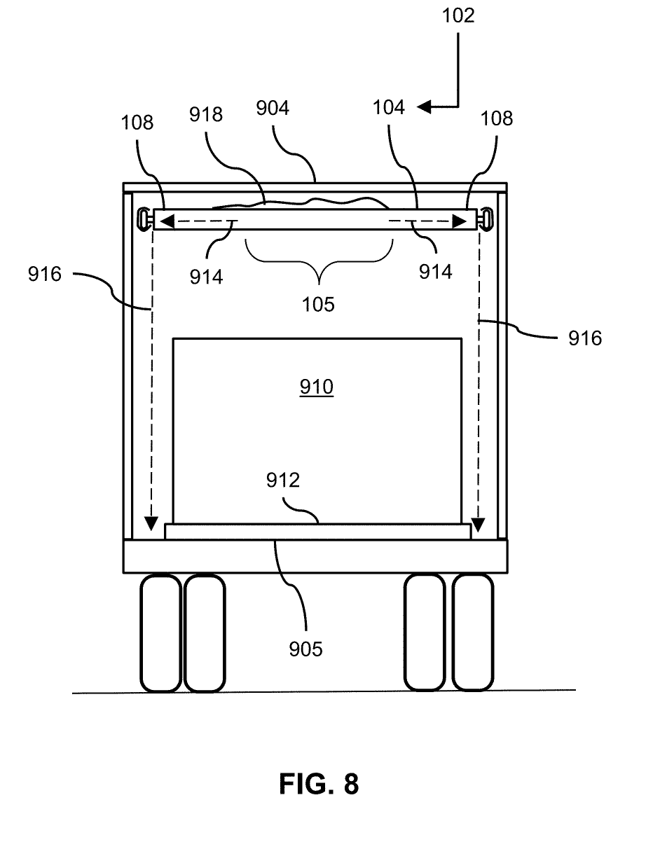

FIG. 8 depicts a front view of an embodiment of the door assembly including the panel sections of FIG. 1 (in which the panel sections are horizontally aligned);

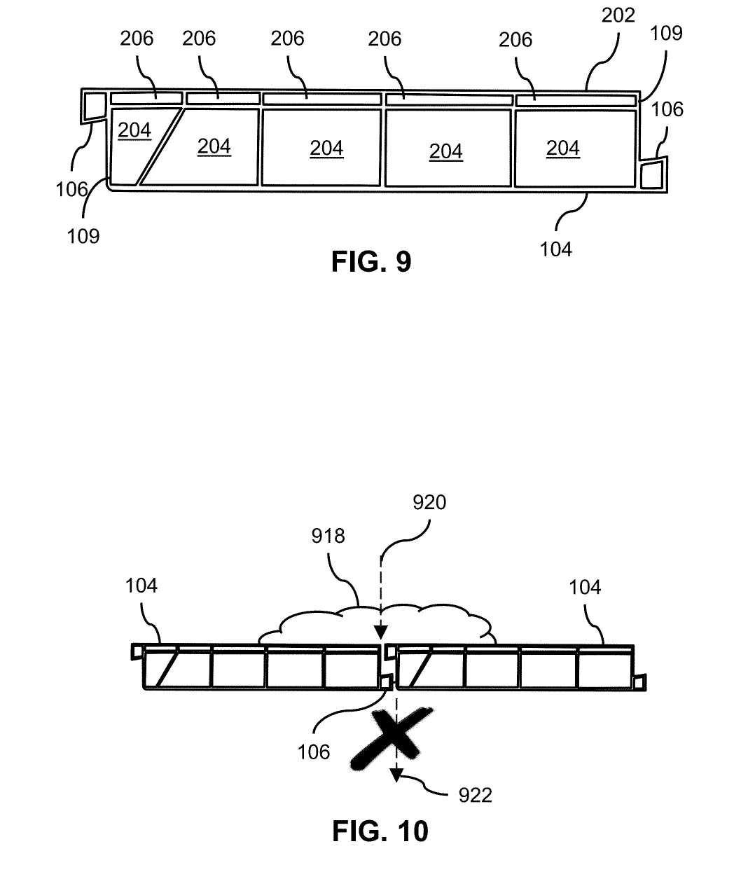

FIG. 9 depicts a cross-sectional view (taken along the cross-sectional line A-A of FIG. 1) of an embodiment of the panel section of the door assembly of FIG. 1;

FIG. 10 depicts a cross-sectional view (taken along the cross-sectional line A-A of FIG. 1) of an embodiment of the panel section of the door assembly of FIG. 1;

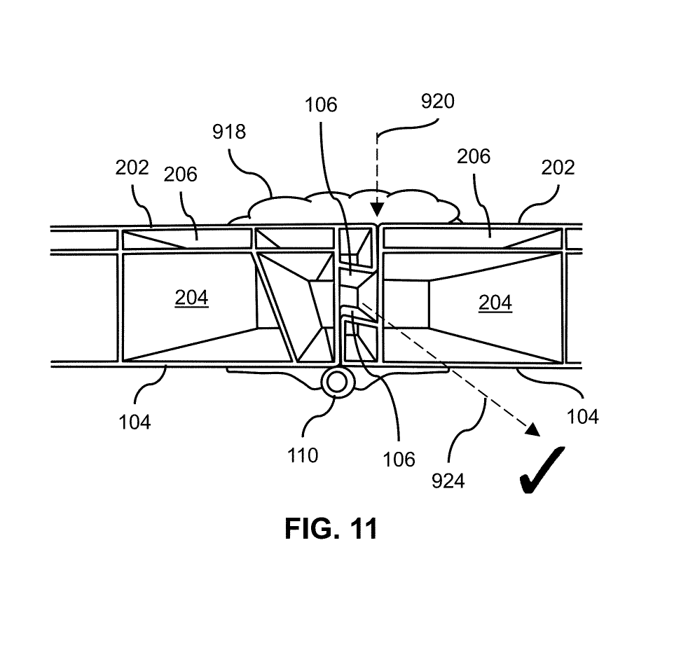

FIG. 11 depicts a close-up cross-sectional view (taken along the cross-sectional line A-A of FIG. 1) of an embodiment of a water drainage assembly associated with the door assembly of FIG. 1;

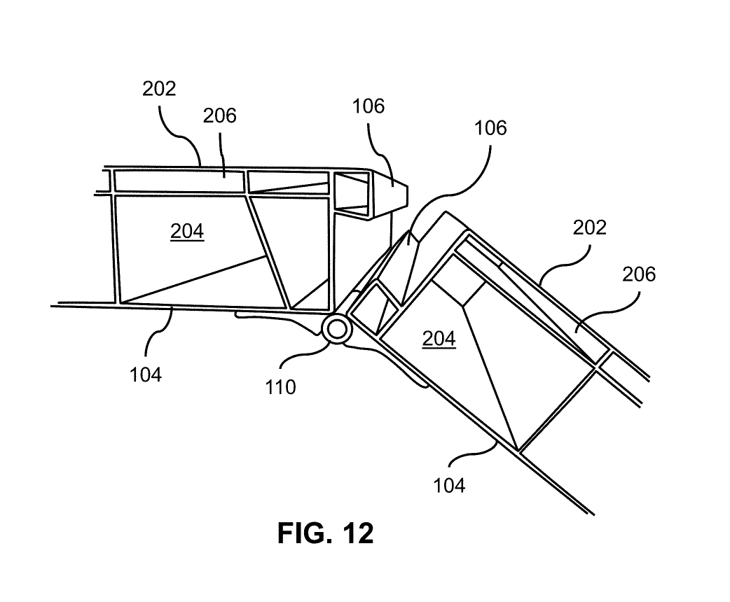

FIG. 12 depicts a close-up perspective cross-sectional view (taken along the cross-sectional line A-A of FIG. 1) of an embodiment of the water drainage assembly associated with the door assembly of FIG. 1;

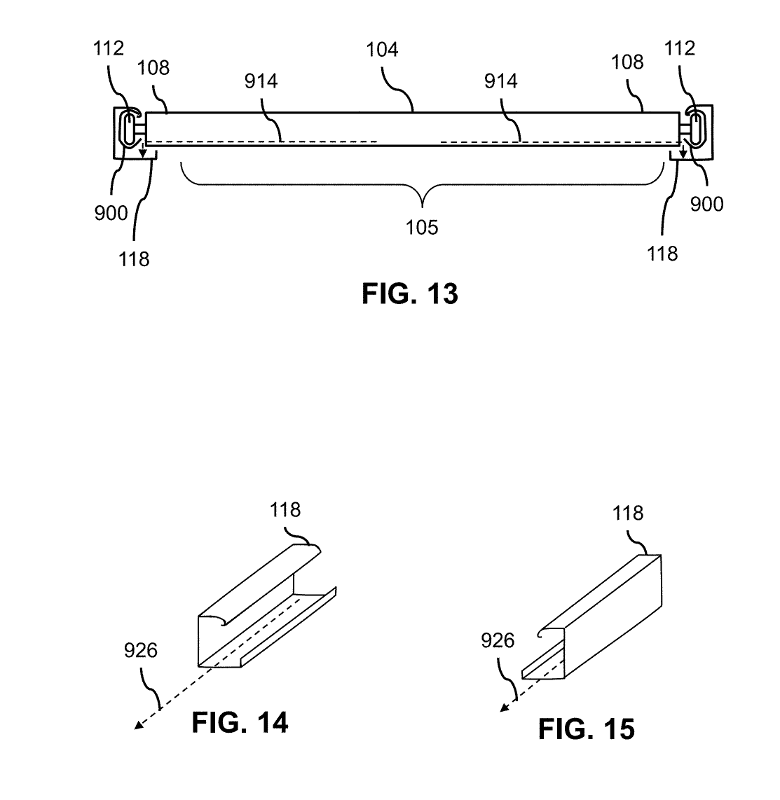

FIG. 13, FIG. 14 and FIG. 15 depict an end view (FIG. 13) and front perspective views (FIG. 14 and FIG. 15) of embodiments of the water drainage assembly associated with the door assembly of FIG. 4;

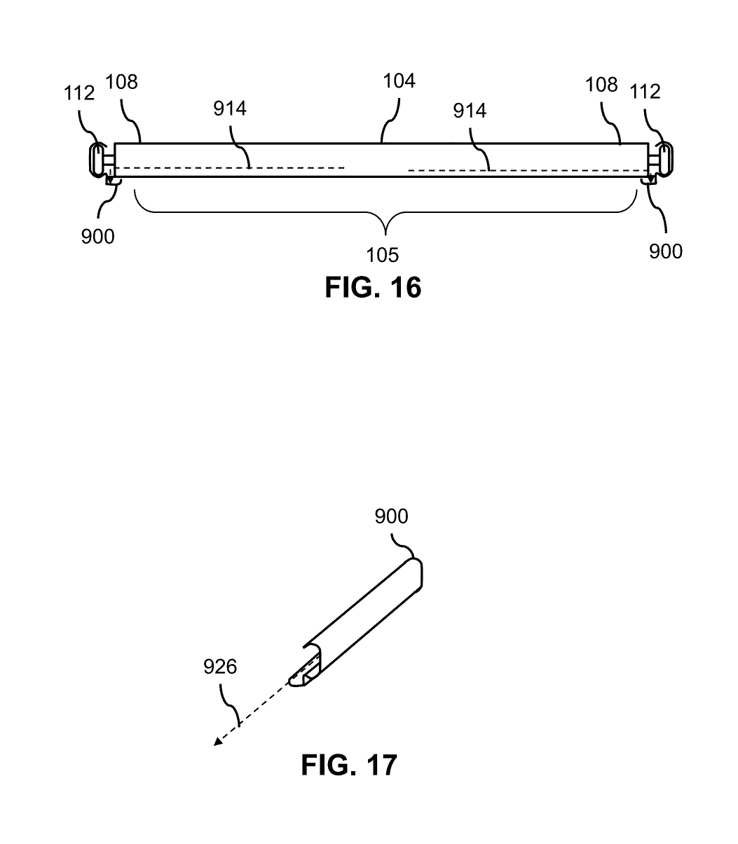

FIG. 16 and FIG. 17 depict an end view (FIG. 16) and a perspective view (FIG. 17) of embodiments of the water drainage assembly associated with the door assembly of FIG. 1;

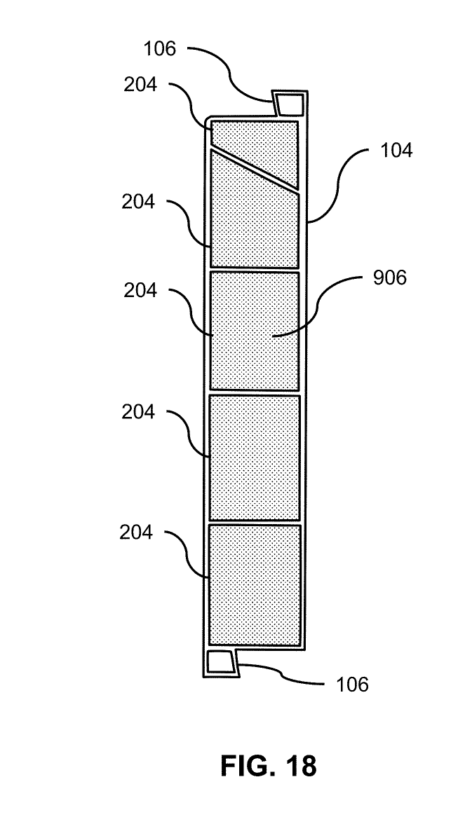

FIG. 18 depicts a cross-sectional side view (taken along the cross-sectional line A-A of FIG. 1) of an embodiment of the panel section of the door assembly of FIG. 1; and

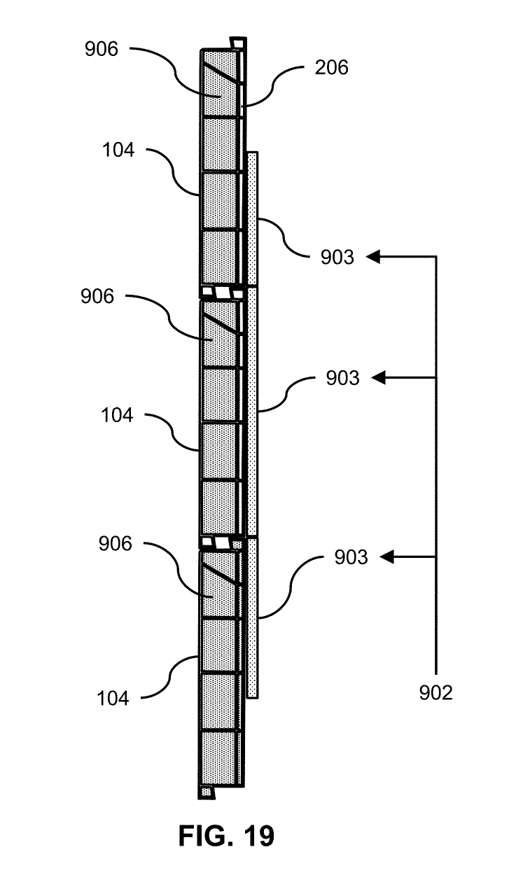

FIG. 19 depicts a cross-sectional side view (taken along the cross-sectional line A-A of FIG. 1) of an embodiment of the panel sections of the door assembly of FIG. 1.

The drawings are not necessarily to scale and may be illustrated by phantom lines, diagrammatic representations and fragmentary views. In certain instances, details unnecessary for an understanding of the embodiments (and/or details that render other details difficult to perceive) may have been omitted. Corresponding reference characters indicate corresponding components throughout the several figures of the drawings. Elements in the several figures are illustrated for simplicity and clarity and have not been drawn to scale. The dimensions of some of the elements in the figures may be emphasized relative to other elements for facilitating an understanding of the various disclosed embodiments. In addition, common, but well-understood, elements that are useful or necessary in commercially feasible embodiments are often not depicted to provide a less obstructed view of the embodiments of the present disclosure.

### LISTING OF REFERENCE NUMERALS USED IN THE DRAWINGS

102 door assembly
104 panel section
105 central zone
106 water drainage assembly
108 opposite peripheral shortened side edges
109 opposite lateral side ends
110 spaced-apart hinges
112 spaced-apart wheels
114 outer side layer
116 hollow frame assembly
118 auxiliary gutter assembly
202 outer panel surface
204 insulation channel
206 cooling channel
900 spaced-apart door tracks
902 logo
903 logo section
904 movable vehicle
905 working surface
906 thermal insulation material
908 garage
910 cargo load
912 pallet
914 directionally-aligned drain path (or horizontal drain path)
916 vertical drain path
918 snow and ice (or rain, any type or precipitation)
920 panel-entrance path
922 vertical path
924 panel drain path (or panel horizontal drain path)
926 lateral direction

### DETAILED DESCRIPTION OF THE NON-LIMITING EMBODIMENT(S)

The following detailed description is merely exemplary and is not intended to limit the described embodiments or the application and uses of the described embodiments. As used, the word “exemplary” or “illustrative” means “serving as an example, instance, or illustration.” Any implementation described as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure. The scope of may be defined by the claims (in which the claims may be amended during patent examination after filing of this application). For the description, the terms “upper,” “lower,” “left,” “rear,” “right,” “front,” “vertical,” “horizontal,” and derivatives thereof shall relate to the examples as oriented in the drawings. There is no intention to be bound by any expressed or implied theory in the preceding Technical Field, Background, Summary or the following detailed description. It is also to be understood that the devices and processes illustrated in the attached drawings, and described in the following specification, are exemplary embodiments (examples), aspects and/or concepts defined in the appended claims. Hence, dimensions and other physical characteristics relating to the embodiments disclosed are not to be considered as limiting, unless the claims expressly state otherwise. It is understood that the phrase “at least one” is equivalent to “a”. The aspects (examples, alterations, modifications, options, variations, embodiments and any equivalent thereof) are described regarding the drawings. It should be understood that the invention is limited to the subject matter provided by the claims, and that the invention is not limited to the particular aspects depicted and described.

FIG. 1 depicts a perspective view of an embodiment of spaced-apart door tracks 900 configured to support a door assembly 102 including panel sections 104.

The door assembly 102 may include any type of material (metal, wood, etc.). The spaced-apart door tracks 900 may be made of metal. There are two major aspects of the door assembly 102. A first major aspect of the door assembly 102 is best depicted in FIG. 11, with FIGS. 1-10 and 12-19 supporting the first general concept. A second major aspect of the door assembly 102 is best depicted in FIG. 19, with FIG. 1 to FIG. 18 supporting the second general concept. The door assembly 102 may be called a roll-up door assembly.

Referring to the embodiment as depicted in FIG. 1, the door assembly 102 includes (and is not limited to) a synergistic combination of panel sections 104 configured to be pivotally coupled (pivotally connectable) with each other. The panel sections 104 may include any type of suitable material (such as, and not limited to, metal, wood, fiberglass, thermoplastic material, etc., and any equivalent thereof in any combination and permutation thereof.). This is done in such a way that the panel sections 104 are positioned in an end-to-end relationship relative to each other. The meaning or definition of “end-to-end relationship” is that the opposite longitudinal sides of the panel sections 104 are positioned or oriented end-to-end (facing end-to-end). In addition, the panel sections 104 are also configured to be movably coupled to spaced-apart door tracks 900. This is done in such a way that the panel sections 104 are movable along the spaced-apart door tracks 900 between a first position, in which the panel sections 104 are vertically aligned (as depicted in FIGS. 1 to 6, 18 and 19), and a second position, in which the panel sections 104 are aligned (such as, horizontally aligned, as depicted in FIGS. 8 to 11, 13 and 16).

Each of the panel sections 104 includes opposite peripheral shortened side edges 108 (also called lateral side ends, lateral end portions or side ends). The opposite peripheral shortened side edges 108 are spaced apart from each other. The opposite peripheral shortened side edges 108 are located on opposite sides of the panel sections 104. Each of the panel sections 104 includes or provides opposite lateral side ends 109 that are spaced apart from each other. The opposite peripheral shortened side edges 108 and the opposite lateral side ends 109 surround the central zone 105. The combination of the opposite lateral side ends 109 and the opposite peripheral shortened side edges 108 define (or outline) an interior rectilinear shape (such as a rectangular shape or a square shape).

The door assembly 102 also includes spaced-apart hinges 110 and spaced-apart wheels 112. The spaced-apart hinges 110 (which may be made of metal) are mounted to the opposite lateral side ends 109 of the panel sections 104 (at the midsections of the panel sections 104). The spaced-apart hinges 110 are configured to pivotally couple (pivotally connect) the panel sections 104 with each other, one panel section after another panel section (so that the panel sections 104 are positioned in an end-to-end relationship relative to each other). The spaced-apart wheels 112 (which may be made of metal, plastic, nylon, etc.) are mounted to the opposite peripheral shortened side edges 108 of the panel sections 104 (preferably, mounted at the corners of the panel section 104). The spaced-apart wheels 112 are configured to movably engage (roll engage) the spaced-apart door tracks 900.

FIG. 2 depicts a perspective view of an embodiment of the door assembly 102 of FIG. 1, in which the door assembly 102 is configured to be used in association with a movable vehicle 904.

Referring to the embodiment as depicted in FIG. 2, the door assembly 102 is configured to be installed or mounted to a movable vehicle 904, such as a delivery truck, etc. The spaced-apart door tracks 900 are mounted to the interior ceiling of the movable vehicle 904. A logo 902 is configured to be mounted to a portion of the outer surfaces of at least one or more of the panel sections 104. For instance, the logo 902 may be configured to provide (display) an indication of the contents (cargo) that are contained within the movable vehicle 904. The logo 902 is mounted to at least some of the panel sections 104 with an adhesive. It will be appreciated that the logo 902 is formed into logo sections or logo portions, in which a logo portion is mounted to a single instance of the panel section 104, etc.

FIG. 3 depicts a perspective view of an embodiment of the door assembly 102 of FIG. 1, in which the door assembly 102 is configured to be used in association with a building.

Referring to the embodiment as depicted in FIG. 3, the door assembly 102 is configured to be installed or mounted to a building, such as a garage 908 of the building, etc. The spaced-apart door tracks 900 are mounted to the interior ceiling of the garage 908.

FIG. 4 depicts a cross-sectional side view (taken along the cross-sectional line A-A of FIG. 1) of an embodiment of the panel section 104 of the door assembly 102 of FIG. 1, in which the panel section 104 is aligned (such as, vertically aligned or aligned in a predetermined direction).

Referring to the embodiment as depicted in FIG. 4, the panel section 104 provides an outer panel surface 202. The panel section 104 is configured to form or include a hollow frame assembly 116 having interconnected frame members forming spaced-apart hollow sections or channels, such as an insulation channel 204 and a cooling channel 206 that are positioned adjacent to (proximate to) the insulation channel 204. The hollow frame assembly 116 may be manufactured using an extrusion machine. The insulation channel 204 is configured to receive a thermal insulation material 906 (such as a solid foam material). The cooling channel 206 is configured to remain hollow and receive air. The insulation channels 204 are stacked (positioned) one next to the other. The cooling channels 206 are stacked (positioned) one against the other.

The panel section 104 includes or provides the opposite lateral side ends 109 (also depicted in FIG. 1), which are spaced apart from each other. The panel section 104 is configured to support a water drainage assembly 106. The water drainage assembly 106 may include any type of suitable material (such as, and not limited to, metal, wood, plastic, fiberglass, thermoplastic material, etc., and any equivalent thereof in any combination and permutation thereof). The water drainage assembly 106 is aligned along the opposite lateral side ends 109 of the panel section 104. Preferably, each of the panel sections 104 (as depicted in FIG. 1) is configured to support a water drainage assembly 106, and the water drainage assembly 106 is aligned along the opposite lateral side ends 109 of each of the panel sections 104. The water drainage assembly 106 may be an integral extension of the panel section 104. The water drainage assembly 106 may be configured to be securely attached to the panel section 104, such as with the SCOTCH (TRADEMARK) mounting tape (catalogue number 4011C) manufactured and/or supplied by the 3M Company (formerly known as the Minnesota Mining and Manufacturing Company) located in Minnesota, United States.

FIG. 5 depicts a cross-sectional side view (taken along the cross-sectional line A-A of FIG. 1) of an embodiment of the panel section 104 of the door assembly 102 of FIG. 1, in which the panel section 104 is aligned (such as, vertically aligned).

Referring to the embodiment as depicted in FIG. 5, the panel section 104 includes an outer side layer 114, such as a coating of a sealant, a rubberized material, etc. The outer side layer 114 is formed on (placed on) the side portions of the panel section 104. The outer side layer 114 is configured to cover up and conceal the insulation channel 204 and the cooling channel 206 (as depicted in FIG. 4). The outer side layer 114 may be called an end portion or an end section.

FIG. 6 and FIG. 7 depict a front view (FIG. 6) and a bottom view (FIG. 7) of an embodiment of the door assembly 102 of FIG. 1, in which the panel sections 104 are aligned (such as, vertically aligned).

Referring to the embodiments as depicted in FIG. 6 and FIG. 7, the panel section 104 includes or provides the opposite peripheral shortened side edges 108 that are spaced apart from each other. The panel sections 104 include or provide the opposite lateral side ends 109 that are spaced apart from each other. The insulation channel 204 (as depicted in FIG. 6) and the cooling channel 206 (as depicted in FIG. 6) extend between the opposite peripheral shortened side edges 108. The insulation channel 204 (as depicted in FIG. 6) and the cooling channel 206 (as depicted in FIG. 6) extend along a length of the opposite lateral side ends 109.

FIG. 8 depicts a front view of an embodiment of the door assembly 102 including the panel sections 104 of FIG. 1, in which the panel sections 104 are aligned (such as, horizontally aligned, or vertically aligned, or other alignment direction, etc.).

Referring to the embodiment as depicted in FIG. 8, the door assembly 102 is positioned in an alignment direction (such as, a horizontal alignment) in such a way that the interior of the movable vehicle 904 is revealed. The movable vehicle 904 has a working surface 905 configured to support a pallet 912 (made of wood, etc.) carrying (receiving) a cargo load 910 (such as boxed food goods received in a cardboard box, etc.). The pallet 912 is high enough so that the water accumulating on the working surface 905 does not corrupt the cargo load 910 with moisture (water). A problem (to be resolved at least in part) is water inadvertently dripping downwardly from the central midsections of the panel sections 104 (once they are positioned in an alignment orientation, such as horizontally, etc.) directly onto the cargo load 910 that is positioned directly below the midsections of the panel sections 104.

The panel section 104 is configured to form or provide a directionally-aligned drain path 914 (which may be called a directionally-aligned drain path 914) that extends from the central zone 105 of the panel sections 104 to the opposite peripheral shortened side edges 108 of the panel sections 104.

Snow and ice 918 (which may include rain or any type or precipitation) are positioned on the outer surface of the panel sections 104 of the door assembly 102. For the case where the snow and ice 918 melt and form water, the water will flow along the directionally-aligned drain path 914 that extends from the central zone 105 of the panel sections 104 to the opposite peripheral shortened side edges 108 of the panel sections 104.

Once the water reaches the opposite peripheral shortened side edges 108 of the panel sections 104, the water will flow along a vertical drain path 916 extending from the opposite peripheral shortened side edges 108 of the panel sections 104 toward the outer edges (outer peripheral edges) of the working surface 905 of the movable vehicle 904.

FIG. 9 depicts a cross-sectional view (taken along the cross-sectional line A-A of FIG. 1) of an embodiment of the panel section 104 of the door assembly 102 of FIG. 1, in which the panel section 104 is aligned or oriented (such as, horizontally aligned).

Referring to the embodiment as depicted in FIG. 9, the insulation channels 204 (formed by the panel section 104) are positioned one after the other along a length of the panel section 104. The cooling channel 206 (formed by the panel section 104) are positioned one after the other along a length of the panel section 104.

FIG. 10 depicts a cross-sectional view (taken along the cross-sectional line A-A of FIG. 1) of an embodiment of the panel section 104 of the door assembly 102 of FIG. 1, in which the panel section 104 is aligned (such as, horizontally aligned) in an end-to-end relationship relative to another panel section 104.

Referring to the embodiment as depicted in FIG. 10, the snow and ice 918 (or water from rain) are positioned on the outer surfaces of neighboring instances of the panel section 104. A panel-entrance path 920 (for receiving a flow of water from the snow and ice 918 or rain) is positioned between the neighboring instances of the panel section 104.

The water drainage assembly 106 of the panel section 104 is positioned adjacent to (and in contact with) a neighboring instance of the panel section 104. This is done in such a way that the water drainage assembly 106, in use, prevents the flow of water via a vertical path 922, in which the vertical path 922 is positioned between neighboring instances of the panel section 104.

FIG. 11 depicts a close-up cross-sectional view (taken along the cross-sectional line A-A of FIG. 1) of an embodiment of a water drainage assembly 106 associated with the door assembly 102 of FIG. 1, in which the panel section 104 is aligned (horizontally aligned) in an end-to-end relationship relative to another panel section 104.

There are two major aspects of the door assembly 102, in which the first major aspect of the door assembly 102 is best depicted in FIG. 11, with FIGS. 1-10 and 12-18 supporting the first major aspect.

In accordance with the first major aspect of the door assembly 102, the door assembly 102 further includes a synergistic combination of a water drainage assembly 106 in combination with the panel section 104.

Referring to the embodiment as depicted in FIG. 11, the water drainage assembly 106 is configured to (in no particular order): (A) be positioned between the panel sections 104, (B) receive, at least in part, water positioned on a surface of the panel sections 104 once the panel sections 104 are aligned (preferably, horizontally aligned), and (C) direct a flow of the water toward opposite peripheral shortened side edges 108 of the panel sections 104. A technical effect of the above arrangement for the water drainage assembly 106 of the panel sections 104 is that the water drainage assembly 106 cooperates with the panel sections 104 to reduce (preferably prevent) the flow of water (A) through the panel sections 104 via a panel horizontal drain path 924, which may be called a panel drain path (once the panel sections 104 are aligned (horizontally aligned) or positioned (horizontally positioned) as depicted in FIG. 8 and FIG. 11), and (B) toward a central floor area positioned directly underneath (or directly behind or behind) the panel sections 104 that are positioned (such as, positioned horizontally, as depicted in FIG. 8 and FIG. 11). The water drainage assembly 106, in use, avoids the release of water toward a central floor area positioned directly underneath (or directly behind or behind) the panel sections 104 that are positioned (such as, positioned horizontally). To achieve this technical effect, the opposite peripheral shortened side edges 108 of the panel sections 104, in use, receive the flow of water and thereby the flow of water is directed away from the central floor area that is positioned directly underneath (or directly behind or behind) the panel sections 104 that are positioned (horizontally positioned, as depicted in FIG. 11).

Preferably, the water drainage assembly 106 forms or provides a valley shape.

Referring to the embodiments as depicted in FIG. 1, FIG. 8 and FIG. 11, there is provided a major embodiment, in which the apparatus includes a combination of the door assembly 102, the panel sections 104 and the water drainage assembly 106 for original equipment manufacturing. The door assembly 102 includes panel sections 104. The water drainage assembly 106 is configured to (A) be located, at least in part, between the panel sections 104, (B) receive, in use, a flow of water from the panel sections 104 once the panel sections 104 are aligned (such as, horizontally aligned) in the second position, (C) direct, in use, the flow of water away from the panel sections 104, and (D) direct, in use, the flow of water downwardly from the panel sections 104 in such a way that the water drainage assembly 106, in use, diverts conveyance of the flow of water away from a working surface 905 located directly underneath (or directly behind or behind) a central zone 105 of the panel sections 104 once the panel sections 104 are aligned (such as horizontally aligned).

Referring to the embodiments as depicted in FIG. 1, FIG. 8 and FIG. 11, there is provided a major embodiment, in which the apparatus includes a combination of the door assembly 102, the panel sections 104 and the water drainage assembly 106 for original equipment manufacturing. The door assembly 102 includes the panel sections 104 configured to (A) be pivotally coupled with each other in such a way that the panel sections 104 are positioned in an end-to-end relationship relative to each other, (B) have an outer panel surface 202 configured to receive moisture (such as snow and ice 918, or rain or any type or precipitation), (C) have a central zone 105, (D) have opposite peripheral shortened side edges 108 positioned on opposite sides of the central zone 105, (E) have opposite lateral side ends 109 extending between the opposite peripheral shortened side edges 108, and (F) be movably coupled to spaced-apart door tracks 900 in such a way that the panel sections 104 are movable along the spaced-apart door tracks 900 between a first position, in which the panel sections 104 are aligned (vertically aligned or aligned in a first predetermined alignment direction), and a second position, in which the panel sections 104 are aligned (such as, horizontally aligned or aligned in a second predetermined alignment direction).

The water drainage assembly 106 is configured to be located, at least in part, between the panel sections 104 (specifically, located between neighboring instances of the panel sections 104). This is done in such a way that the water drainage assembly 106 is securely positioned between, at least in part, the panel sections 104 once the panel sections 104 are aligned (such as, horizontally aligned) in the second position. The water drainage assembly 106 is also configured to provide a directionally-aligned drain path 914 (also called a horizontal drain path) extending along the opposite lateral side ends 109 of the panel sections 104 extending from the central zone 105 of the panel sections 104 to the opposite peripheral shortened side edges 108 of the panel sections 104. This is done in such a way that the directionally-aligned drain path 914: (A) receives, in use, a flow of water from the moisture (such as, snow and ice 918, or rain, etc.) positioned on the outer panel surface 202 of the panel sections 104 once the panel sections 104 are aligned (horizontally aligned) in the second position, (B) directs, in use, the flow of water away from the central zone 105 of the panel sections 104 and toward the opposite peripheral shortened side edges 108 of the panel sections 104, and (C) directs, in use, the flow of water along a vertical drain path 916 extending downwardly from the opposite peripheral shortened side edges 108 of the panel sections 104 once the flow of water reaches the opposite peripheral shortened side edges 108 of the panel sections 104. The water drainage assembly 106, in use, directs, in use, the flow of water downwardly from the panel sections 104 in such a way that the water drainage assembly 106, in use, diverts conveyance of the flow of water away from a working surface 905 located directly underneath (or directly behind or behind) a central zone 105 of the panel sections 104 once the panel sections 104 are aligned (horizontally aligned). The water drainage assembly 106, in use, avoids conveyance of the flow of water, once the panel sections 104 are aligned (horizontally aligned), from the central zone 105 of the panel sections 104 to a working surface 905 located directly underneath (or directly behind or behind) the central zone 105 of the panel sections 104. A technical effect of this arrangement is that the water drainage assembly 106, in use, avoids the flow of water (the inadvertent dropping of water) onto an object (such as, a cargo load 910 supported by a pallet 912 or a vehicle stored in a garage, etc.) positioned under the door assembly 102.

In accordance with an option, the water drainage assembly 106 is configured to be integral with, and to extend from, the opposite lateral side ends 109 extending between the opposite peripheral shortened side edges 108 of the panel sections 104. The water drainage assembly 106 is configured to be aligned along the opposite lateral side ends 109 of the panel section 104. In accordance with another option, the door assembly 102 is configured to be installed to a movable vehicle 904. The spaced-apart door tracks 900 are configured to be mounted to the interior ceiling of the movable vehicle 904.

In accordance with yet another option, the door assembly 102 is configured to be installed to (in) a building. The spaced-apart door tracks 900 are configured to be mounted to the interior ceiling of the garage 908.

Referring to the embodiments as depicted in FIG. 1, FIG. 8 and FIG. 11, there is provided a major embodiment, in which the apparatus includes the water drainage assembly 106 that is configured to be retrofitted to an existing instance of the door assembly 102 including the panel sections 104. The water drainage assembly 106 is configured for use with the panel sections 104 of the door assembly 102. The panel sections 104 are configured to: (A) be pivotally coupled with each other in such a way that the panel sections 104 are positioned in an end-to-end relationship relative to each other; (B) have an outer panel surface 202 configured to receive moisture (such as snow and ice 918, rain, or any type or precipitation); (C) have a central zone 105; (D) have opposite peripheral shortened side edges 108 positioned on opposite sides of the central zone 105; (E) have opposite lateral side ends 109 extending between the opposite peripheral shortened side edges 108; and (F) be movably coupled to spaced-apart door tracks 900 in such a way that the panel sections 104 are movable along the spaced-apart door tracks 900 between a first position, in which the panel sections 104 are aligned (such as, vertically aligned), and a second position, in which the panel sections 104 are aligned (horizontally aligned).

The water drainage assembly 106 is configured to: (A) be located, at least in part, between the panel sections 104 (specifically, located between neighboring instances of the panel sections 104) in such a way that the water drainage assembly 106 is securely positioned between, at least in part, the panel sections 104 once the panel sections 104 are aligned (horizontally aligned) in the second position; and (B) provide the directionally-aligned drain path 914 (also called the directionally-aligned drain path 914) extending along the opposite lateral side ends 109 of the panel sections 104 extending from the central zone 105 of the panel sections 104 to the opposite peripheral shortened side edges 108 of the panel sections 104. This is done in such a way that the directionally-aligned drain path 914: (A) receives, in use, a flow of water from the moisture (such as, snow and ice 918, water from rain, etc.) positioned on the outer panel surface 202 of the panel sections 104 once the panel sections 104 are aligned (horizontally) aligned in the second position; (B) directs, in use, the flow of water away from the central zone 105 of the panel sections 104 and toward the opposite peripheral shortened side edges 108 of the panel sections 104; and (C) directs, in use, the flow of water along a vertical drain path 916 extending downwardly from the opposite peripheral shortened side edges 108 of the panel sections 104 once the flow of water reaches the opposite peripheral shortened side edges 108 of the panel sections 104. The water drainage assembly 106, in use, directs the flow of water downwardly from the panel sections 104 in such a way that the water drainage assembly 106, in use, diverts conveyance of the flow of water away from a working surface 905 located directly underneath (or directly behind or behind) a central zone 105 of the panel sections 104 once the panel sections 104 are aligned (such as horizontally aligned). The water drainage assembly 106, in use, avoids conveyance of the flow of water, once the panel sections 104 are aligned (such as, horizontally aligned), from the central zone 105 of the panel sections 104 to a working surface 905 located directly underneath (or directly behind or behind) the central zone 105 of the panel sections 104. A technical effect is that the water drainage assembly 106, in use, avoids the flow of water (the inadvertent dropping of water) onto an object (such as, a cargo load 910 supported by a pallet 912 or a vehicle stored in a garage, etc.) positioned under the door assembly 102.

In accordance with an option, the water drainage assembly 106 is configured to be adhesively attached to the opposite lateral side ends 109 extending between the opposite peripheral shortened side edges 108 of the panel sections 104. The water drainage assembly 106 is configured to be aligned along the opposite lateral side ends 109 of the panel section 104. In accordance with another option, the water drainage assembly 106 is configured to be integral with, and to extend from, the opposite lateral side ends 109 extending between the opposite peripheral shortened side edges 108 of the panel sections 104. In accordance with yet another option, the water drainage assembly 106 is configured to be snap fitted to the opposite lateral side ends 109 extending between the opposite peripheral shortened side edges 108 of the panel sections 104.

FIG. 12 depicts a close-up perspective cross-sectional view (taken along the cross-sectional line A-A of FIG. 1) of an embodiment of the water drainage assembly 106 associated with the door assembly 102 of FIG. 1, in which the panel section 104 is pivotally positioned relative to another panel section 104.

Referring to the embodiment as depicted in FIG. 12, the neighboring instances of the panel section 104 are pivoted apart from each other for improved view of the water drainage assembly 106.

FIG. 13, FIG. 14 and FIG. 15 depict an end view (FIG. 13 depicts the alignment (horizontal alignment) of the panel section 104) and front perspective views (FIG. 14 and FIG. 15) of embodiments of the water drainage assembly 106 associated with the door assembly 102 of FIG. 4.

Referring to the embodiment as depicted in FIG. 13, the door assembly 102 further includes a gutter assembly 118, which may be called an auxiliary gutter assembly, a gutter track, a gutter collector, etc. The gutter assembly 118 may be manufactured using an extrusion machine. The gutter assembly 118 is configured to connect (couple or snap fit) to the spaced-apart door tracks 900, and to fluidly cooperate with (be in fluid communication with) the water drainage assembly 106 associated with the panel sections 104 of the door assembly 102, in which the door assembly 102 is configured to be operatively mounted to the spaced-apart door tracks 900. This is done in such a way that the gutter assembly 118, in use, receives the flow of water (along the directionally-aligned drain path 914) from the water drainage assembly 106 at the opposite peripheral shortened side edges 108 of the panel sections 104. The gutter assembly 118 is configured to be retrofitted to existing instances of the spaced-apart door tracks 900.

Referring to the embodiments as depicted in FIG. 14 and FIG. 15, once the flow of water (along the directionally-aligned drain path 914) is received by the gutter assembly 118 from the water drainage assembly 106, the gutter assembly 118 is configured to direct (channel) the flow of water along a lateral direction 926 (along an elongated length of the gutter assembly 118) toward the position in which the door assembly 102 is positioned in a vertical alignment (orientation) as depicted in FIG. 1.

FIG. 16 and FIG. 17 depict an end view (FIG. 16 depicts the alignment of (horizontal alignment) of the panel section 104) and a perspective view (FIG. 17) of embodiments of the water drainage assembly 106 associated with the door assembly 102 of FIG. 1.

Referring to the embodiment as depicted in FIG. 16, the spaced-apart door tracks 900 (wheel track) is configured to form or provide an integrated gutter assembly (similar to the gutter assembly 118 as depicted in FIG. 13). The spaced-apart door tracks 900 that is integrated with the gutter assembly 118 is configured to fluidly cooperate with (be in fluid communication with) the water drainage assembly 106 of the panel sections 104. This is done in such a way that the spaced-apart door tracks 900, in use, receives the flow of water (along the directionally-aligned drain path 914) from the water drainage assembly 106 at the opposite peripheral shortened side edges 108 of the panel sections 104.

Referring to the embodiments as depicted in FIG. 17, once the flow of water (along the directionally-aligned drain path 914) is received by the spaced-apart door tracks 900 from the water drainage assembly 106, the spaced-apart door tracks 900 is configured to direct (channel) the flow of water along a lateral direction 926 (along an elongated length of the spaced-apart door tracks 900) toward the position in which the door assembly 102 is positioned in a vertical alignment (orientation) as depicted in FIG. 1.

FIG. 18 depicts a cross-sectional side view (taken along the cross-sectional line A-A of FIG. 1) of an embodiment of the panel section 104 of the door assembly 102 of FIG. 1, in which the panel section 104 is aligned (such as, vertically aligned), and in which the panel section 104 includes a thermal insulation material 906.

Referring to the embodiment as depicted in FIG. 18, the panel section 104 provides (defines) the insulation channel 204, in which the insulation channel 204 is configured to receive the thermal insulation material 906. The panel section 104 does not provide a cooling channel (in which the cooling channel 206 is depicted in FIG. 4).

FIG. 19 depicts a cross-sectional side view (taken along the cross-sectional line A-A of FIG. 1) of an embodiment of the panel sections 104 of the door assembly 102 of FIG. 1, in which the panel sections 104 are aligned (vertically aligned), and in which the panel section 104 includes a thermal insulation material 906.

There are two major aspects of the door assembly 102, in which the second major aspect of the door assembly 102 is best depicted in FIG. 19, with FIG. 1 to FIG. 18 supporting the second major aspect.

The door assembly 102 includes (and is not limited to) a synergistic combination of the panel sections 104 configured to be pivotally coupled (pivotally connectable) with each other. This is done in such a way that the panel sections 104 are positioned in an end-to-end relationship relative to each other. In addition, the panel sections 104 are also configured to be movably coupled to spaced-apart door tracks 900. This is done in such a way that the panel sections 104 are movable along the spaced-apart door tracks 900 between a first position, in which the panel sections 104 are aligned (vertically aligned, as depicted in FIGS. 1 to 6, 18 and 19), and a second position, in which the panel sections 104 are aligned (horizontally aligned, as depicted in FIGS. 8 to 11, 13 and 16).

In accordance with the second major aspect of the door assembly 102, the door assembly 102 further includes a synergistic combination of an insulation channel 204 and a cooling channel 206 in combination with the panel section 104.

The panel sections 104 have (provide) an outer panel surface 202 configured to receive and support a logo 902. The outer panel surface 202 may include a coating of a sealant, a rubberized material, etc. formed on (placed on) the planar portion of the panel section 104. The panel sections 104 are configured to form an insulation channel 204 configured to receive a thermal insulation material 906. This is done in such a way that the thermal insulation material 906, in use, builds up heat energy on the outer panel surface 202 of the panel sections 104 having the logo 902.

The panel sections 104 are also configured to form a cooling channel 206 configured to receive air. The cooling channel 206 is configured to be positioned proximate to the insulation channel 204. This is done in such a way that the cooling channel 206, in use, receives the heat energy from the outer panel surface 202 of the panel sections 104 having the logo 902. The technical effect of the cooling channel 206 is that the outer panel surface 202 of the panel sections 104 is less likely to inadvertently buckle in response to receiving the heat energy, and the logo 902 installed to the panel sections 104 does not warp in response to the outer panel surface 202 inadvertently being buckled as a result of the outer panel surface 202, in use, receiving heat (since the heat is taken away by the cooling channel 206). A technical effect of the above arrangement for the cooling channel 206 of the door assembly 102 is that the cooling channel 206 cooperates with the door assembly 102 so that the outer panel surface 202 of the panel sections 104 is less likely to inadvertently buckle in response to receiving the heat energy, and the logo 902 installed to the panel sections 104 does not warp in response to the outer panel surface 202 being buckled (as a result of the outer panel surface 202 receiving the heat energy (since the heat is taken away by the cooling channel 206). The cooling channel 206, in use, reduces (preferably eliminates) the possibility of the logo 902 becoming warped (distorted, broken or separated, at least in part, from the panel sections 104) as a result of the thermal insulation material 906 contained or supported by the panel sections 104 becoming overheated.

The logo 902 includes the logo sections 903 each configured to be attached to, and supported by, a single instance of the panel section 104. Specifically, the logo 902 is formed into separate images mounted on respective pieces of a medium, etc. The logo 902 includes a relatively thin ply of vinyl material having an image printed thereon. The logo 902 is adhesively attached to the panel sections 104.

Referring to the embodiments as depicted in FIG. 1 and FIG. 19, there is provided a major embodiment, in which the apparatus includes the cooling channel 206 that is configured to be retrofitted to an existing instance of the door assembly 102 including the panel sections 104. The cooling channel 206 is configured for use with the panel sections 104 to be used with a door assembly 102. The panel sections 104 are configured to: (A) be pivotally coupled with each other in such a way that the panel sections 104 are positioned in an end-to-end relationship relative to each other; (B) have an outer panel surface 202 configured to receive and support, at least in part, a logo 902; (C) be movably coupled to spaced-apart door tracks 900 in such a way that the panel sections 104 are movable along the spaced-apart door tracks 900 between a first position, in which the panel sections 104 are aligned (vertically aligned or aligned in a first predetermined alignment direction), and a second position, in which the panel sections 104 are aligned (horizontally aligned or aligned in a second predetermined alignment direction); and (D) provide an insulation channel 204 configured to receive a thermal insulation material 906 in such a way that the thermal insulation material 906, in use, builds up heat energy on the outer panel surface 202 of the panel sections 104 having the logo 902. The cooling channel 206 is configured to: (A) receive air; and (B) be positioned proximate to the insulation channel 204 in such a way that the cooling channel 206, in use, receives the heat energy from the outer panel surface 202 of the panel sections 104 having the logo 902, and conducts the heat energy away from the outer panel surface 202 and the logo 902. The outer panel surface 202 of the panel sections 104 is less likely to inadvertently buckle in response to receiving the heat energy, and the logo 902 installed to the panel sections 104 does not warp in response to the outer panel surface 202 becoming buckled in response to the outer panel surface 202 receiving heat (heat energy).

Referring to the embodiments as depicted in FIG. 1 and FIG. 19, there is provided a major embodiment, in which the apparatus includes the combination of the door assembly 102, the panel sections 104 and the cooling channel 206 for original equipment manufacturing. The door assembly 102 includes panel sections 104 configured to: (A) be pivotally coupled with each other in such a way that the panel sections 104 are positioned in an end-to-end relationship relative to each other; (B) have an outer panel surface 202 configured to receive and support, at least in part, a logo 902; (C) be movably coupled to spaced-apart door tracks 900 in such a way that the panel sections 104 are movable along the spaced-apart door tracks 900 between a first position, in which the panel sections 104 are aligned (vertically aligned), and a second position, in which the panel sections 104 are aligned (horizontally aligned); (D) provide an insulation channel 204 configured to receive a thermal insulation material 906 in such a way that the thermal insulation material 906, in use, builds up heat energy on the outer panel surface 202 of the panel sections 104 having the logo 902; and (E) provide a cooling channel 206 configured to receive air, and the cooling channel 206 being configured to be positioned proximate to the insulation channel 204 in such a way that the cooling channel 206, in use, receives the heat energy from the outer panel surface 202 of the panel sections 104 having the logo 902, and conducts the heat energy away from the outer panel surface 202 and the logo 902. The outer panel surface 202 of the panel sections 104 is less likely to inadvertently buckle in response to receiving the heat energy, and the logo 902 installed to the panel sections 104 does not warp in response to the outer panel surface 202 becoming buckled in response to the outer panel surface 202 receiving heat (heat energy).

Referring to the embodiments as depicted in FIG. 1 and FIG. 19, there is provided a major embodiment, in which there is provided a method of operating the door assembly 102. The method includes receiving and supporting, at least in part, a logo 902 on (attached to) an outer panel surface 202 of the panel sections 104. The panel sections 104 are configured to be pivotally coupled with each other in such a way that the panel sections 104 are positioned in an end-to-end relationship relative to each other. The panel sections 104 are movably coupled to spaced-apart door tracks 900 in such a way that the panel sections 104 are movable along the spaced-apart door tracks 900 between a first position (in which the panel sections 104 are aligned or vertically aligned), and a second position (in which the panel sections 104 are aligned or horizontally aligned). The method further includes providing an insulation channel 204 in the panel sections 104, in which the insulation channel 204 is configured to receive a thermal insulation material 906 in such a way that the thermal insulation material 906, in use, builds up heat energy on the outer panel surface 202 of the panel sections 104 having the logo 902. The method further includes providing a cooling channel 206 in the panel sections 104, in which the cooling channel 206 is configured to receive air. The cooling channel 206 is configured to be positioned proximate to the insulation channel 204 in such a way that the cooling channel 206, in use, receives the heat energy from the outer panel surface 202 of the panel sections 104 having the logo 902, and conducts the heat energy away from the outer panel surface 202 and the logo 902. The outer panel surface 202 of the panel sections 104 is less likely to inadvertently buckle in response to receiving the heat energy, and the logo 902 installed to the panel sections 104 does not warp in response to the outer panel surface 202 becoming buckled in response to the outer panel surface 202 (in use) receiving heat (heat energy).

It is understood that each claim in the claims section is an open ended claim unless stated otherwise. Unless otherwise specified, relational terms used in these specifications should be construed to include certain tolerances that the person skilled in the art would recognize as providing equivalent functionality. By way of example, the term perpendicular is not necessarily limited to 90.0 degrees, and may include a variation thereof that the person skilled in the art would recognize as providing equivalent functionality for the purposes described for the relevant member or element. Terms such as “about” and “substantially”, in the context of configuration, relate generally to disposition, location, or configuration that are either exact or sufficiently close to the location, disposition, or configuration of the relevant element to preserve operability of the element within the invention which does not materially modify the invention. Similarly, unless specifically made clear from its context, numerical values should be construed to include certain tolerances that the person skilled in the art would recognize as having negligible importance as they do not materially change the operability of the invention. It will be appreciated that the description and/or drawings identify and describe embodiments of the apparatus (either explicitly or inherently). The apparatus may include any suitable combination and/or permutation of the technical features as identified in the detailed description, as may be required and/or desired to suit a particular technical purpose and/or technical function. It will be appreciated that, where possible and suitable, any one or more of the technical features of the apparatus may be combined with any other one or more of the technical features of the apparatus (in any combination and/or permutation). It will be appreciated that persons skilled in the art would know that the technical features of each embodiment may be deployed (where possible) in other embodiments even if not expressly stated as such above. It will be appreciated that persons skilled in the art would know that other options would be possible for the configuration of the components of the apparatus to adjust to manufacturing requirements and still remain within the scope as described in at least one or more of the claims. This written description provides embodiments, including the best mode, and also enables the person skilled in the art to make and use the embodiments. The patentable scope may be defined by the claims. The written description and/or drawings may help to understand the scope of the claims. It is believed that all the crucial aspects of the disclosed subject matter have been provided in this document. It is understood, for this document, that the word “includes” is equivalent to the word “comprising” in that both words are used to signify an open-ended listing of assemblies, components, parts, etc. The term “comprising”, which is synonymous with the terms “including,” “containing,” or “characterized by,” is inclusive or open-ended and does not exclude additional, unrecited elements or method steps. Comprising (comprised of) is an “open” phrase and allows coverage of technologies that employ additional, unrecited elements. When used in a claim, the word “comprising” is the transitory verb (transitional term) that separates the preamble of the claim from the technical features of the invention. The foregoing has outlined the non-limiting embodiments (examples). The description is made for particular non-limiting embodiments (examples). It is understood that the non-limiting embodiments are merely illustrative as examples.

What is claimed is:

1. An apparatus, comprising:
a door assembly including panel sections; and
a water drainage assembly configured to:
be located, at least in part, between the panel sections; and
receive, in use, a flow of water from the panel sections once the panel sections are aligned; and
direct, in use, the flow of water away from the panel sections; and
direct, in use, the flow of water downwardly from the panel sections in such a way that the water drainage assembly, in use, diverts conveyance of the flow of water away from a working surface located behind a central zone of the panel sections once the panel sections are aligned.

2. An apparatus, comprising:
a door assembly including panel sections configured to:
be pivotally coupled with each other in such a way that the panel sections are positioned in an end-to-end relationship relative to each other; and
have an outer panel surface configured to receive moisture; and
have a central zone; and
have opposite peripheral shortened side edges positioned on opposite sides of the central zone; and
have opposite lateral side ends extending between the opposite peripheral shortened side edges; and
be movably coupled to spaced-apart door tracks in such a way that the panel sections are movable along the spaced-apart door tracks between a first position, in which the panel sections are aligned, and a second position, in which the panel sections are aligned; and
a water drainage assembly configured to be located, at least in part, between the panel sections in such a way that the water drainage assembly is securely positioned between, at least in part, the water drainage assembly between the panel sections once the panel sections are aligned in the second position.

3. The apparatus of claim 2, wherein:
the water drainage assembly is further configured to provide a directionally-aligned drain path extending along the opposite lateral side ends of the panel sections extending from the central zone of the panel sections to the opposite peripheral shortened side edges of the panel sections.

4. The apparatus of claim 3, wherein:
the directionally-aligned drain path is configured to receive, in use, a flow of water from the moisture positioned on the outer panel surface of the panel sections once the panel sections are aligned in the second position.

5. The apparatus of claim 4, wherein:
the directionally-aligned drain path is further configured to direct, in use, the flow of water away from the central zone of the panel sections and toward the opposite peripheral shortened side edges of the panel sections.

6. The apparatus of claim 5, wherein:
the directionally-aligned drain path is further configured to direct, in use, the flow of water along a vertical drain path extending downwardly from the opposite peripheral shortened side edges of the panel sections once the flow of water reaches the opposite peripheral shortened side edges of the panel sections.

7. The apparatus of claim 6, wherein:
the water drainage assembly, in use, directs the flow of water downwardly from the panel sections in such a way that the water drainage assembly, in use, diverts conveyance of the flow of water away from a working surface located behind the central zone of the panel sections once the panel sections are aligned.

8. The apparatus of claim 2, wherein:
the water drainage assembly is configured to be adhesively attached to the opposite lateral side ends extending between the opposite peripheral shortened side edges of the panel sections; and
the water drainage assembly is configured to be aligned along the opposite lateral side ends of the panel sections.

9. The apparatus of claim 2, wherein:
the water drainage assembly is configured to be integral with, and to extend from, the opposite lateral side ends extending between the opposite peripheral shortened side edges of the panel sections; and
the water drainage assembly is configured to be aligned along the opposite lateral side ends of the panel sections.

10. The apparatus of claim 2, wherein:
the water drainage assembly is configured to be snap fitted to the opposite lateral side ends extending between the opposite peripheral shortened side edges of the panel sections; and
the water drainage assembly is configured to be aligned along the opposite lateral side ends of the panel sections.

11. An apparatus, comprising:
a water drainage assembly configured for use with a door assembly including panel sections configured to: (A) be pivotally coupled with each other in such a way that the panel sections are positioned in an end-to-end relationship relative to each other; (B) have an outer panel surface configured to receive moisture; (C) have a central zone; (D) have opposite peripheral shortened side edges positioned on opposite sides of the central zone; (E) have opposite lateral side ends extending between the opposite peripheral shortened side edges; and (F) be movably coupled to spaced-apart door tracks in such a way that the panel sections are movable along the spaced-apart door tracks between a first position, in which the panel sections are aligned, and a second position, in which the panel sections are aligned; and
the water drainage assembly being configured to be located, at least in part, between the panel sections in such a way that the water drainage assembly is securely positioned between, at least in part, the panel sections once the panel sections are aligned in the second position.

12. The apparatus of claim 11, wherein:
the water drainage assembly is further configured to provide a directionally-aligned drain path extending along the opposite lateral side ends of the panel sections extending from the central zone of the panel sections to the opposite peripheral shortened side edges of the panel sections.

13. The apparatus of claim 12, wherein:
the directionally-aligned drain path is configured to receive, in use, a flow of water from the moisture positioned on the outer panel surface of the panel sections once the panel sections are aligned in the second position.

14. The apparatus of claim 13, wherein:
the directionally-aligned drain path is configured to direct, in use, the flow of water away from the central zone of the panel sections and toward the opposite peripheral shortened side edges of the panel sections.

15. The apparatus of claim 14, wherein:
the directionally-aligned drain path is configured to direct, in use, the flow of water along a vertical drain path extending downwardly from the opposite peripheral shortened side edges of the panel sections once the flow of water reaches the opposite peripheral shortened side edges of the panel sections.

16. The apparatus of claim 15, wherein:
the water drainage assembly, in use, directs the flow of water downwardly from the panel sections in such a way that the water drainage assembly, in use, diverts conveyance of the flow of water away from a working surface located behind the central zone of the panel sections once the panel sections are aligned.

17. The apparatus of claim 11, wherein:
the water drainage assembly is configured to be integral with, and to extend from, the opposite lateral side ends extending between the opposite peripheral shortened side edges of the panel sections; and
the water drainage assembly is configured to be aligned along the opposite lateral side ends of the panel sections.

18. The apparatus of claim 11, wherein:
the door assembly is configured to be installed to a movable vehicle; and
the spaced-apart door tracks are configured to be mounted to an interior ceiling of the movable vehicle.

19. The apparatus of claim 11, wherein:
the door assembly is configured to be installed to a building; and
the spaced-apart door tracks are configured to be mounted to an interior ceiling of a garage.
